(19) United States
(12) Patent Application Publication
(10) Pub. No.: US 2013/0058622 A1
(43) Pub. Date: Mar. 7, 2013

(54) VIDEO WARNING SYSTEMS FOR DEVICES, PRODUCTS, CONTAINERS AND OTHER ITEMS

(71) Applicants: Marty Olson, Brier, WA (US); Josiah N. Olson, Las Vegas, NV (US)

(72) Inventors: Marty Olson, Brier, WA (US); Josiah N. Olson, Las Vegas, NV (US)

(73) Assignee: Vesstech, Inc., Brier, WA (US)

(21) Appl. No.: 13/607,346

(22) Filed: Sep. 7, 2012

Related U.S. Application Data
(60) Provisional application No. 61/531,941, filed on Sep. 7, 2011.

(51) Int. Cl. H04N 5/775

(52) U.S. Cl. 386/230; 386/E05.07

(57) ABSTRACT

Systems and methods for providing video warnings are disclosed herein. A system configured in accordance with one embodiment includes a processor operably coupled to a video screen. A data storage medium containing a video warning can be operably coupled to the processor and an electrical circuit can provide a signal to the processor to initiate display of the video warning on the video screen. In some embodiments, the electrical circuit can include a sensor that produces the signal to initiate the display of the video warning.

### CROSS-REFERENCE TO APPLICATIONS INCORPORATED BY REFERENCE

This application claims priority to U.S. Provisional Application No. 61/531,941, entitled VIDEO WARNING SYSTEMS FOR DEVICES, PRODUCTS, CONTAINERS AND OTHER ITEMS and filed Sep. 7, 2011, the entirety of which is incorporated by reference herein. The subject matter of U.S. Pat. No. 7,772,986, entitled “VERBAL WARNING SYSTEMS AND OTHER AUDIBLE WARNING SYSTEMS FOR USE WITH VARIOUS TYPES OF DEVICES, CONTAINERS, PRODUCTS AND OTHER THINGS,” is incorporated into the present application in its entirety by reference.

This application is related to U.S. patent application Ser. No. ______ (Attorney Docket No. 64515.8004US1), entitled “VIDEO WARNING SYSTEMS FOR DEVICES, PRODUCTS, CONTAINERS AND OTHER ITEMS;” U.S. patent application Ser. No. ______ (Attorney Docket No. 64515.8004US2), entitled “VIDEO WARNING SYSTEMS FOR DEVICES, PRODUCTS, CONTAINERS AND OTHER ITEMS;” and U.S. patent application Ser. No. ______ (Attorney Docket No. 64515.8004US4), entitled “VIDEO WARNING SYSTEMS FOR DEVICES, PRODUCTS, CONTAINERS AND OTHER ITEMS,” filed on Sep. 7, 2012, and each of which is incorporated herein by reference.

### TECHNICAL FIELD

The present disclosure relates generally to warning labels and systems and methods for providing warnings. More particularly, the systems and methods of the present disclosure include video warnings that can be directly associated with devices, equipment, products, containers and other items. Display of the video warnings can be on a video screen that is directly coupled or indirectly coupled to the device, equipment, product, container or other item.

### BACKGROUND

Warning labels attached to various objects have been used for many years in an attempt to alert users to potential hazards associated with use of the objects. Warning labels can be found on virtually any type of product, container, packaging and/or supplemental materials included with a product. For example, a bottle containing a cleaning material can include one or more written warning labels regarding potential dangers associated with the use of the product, instructions in the case of an accident, etc.

One challenge associated with warning labels is the tendency of users to ignore them. Conventional warning labels frequently include a vast amount of information in a relatively small space. Accordingly, the text on the warnings can be printed in a relatively small font that may be difficult for some users to read. A further challenge associated with written warning labels is that they often fail to accommodate illiterate users. Moreover, in the United States, these warnings are typically written in English, thus failing to accommodate non-English literate persons.

One approach to overcoming the foregoing challenges is to include bright colors and graphical symbols on the warning label. Although bright colors and symbols may help direct attention to a warning label, there are often multiple warning labels for virtually every product in use. As such, users can experience warning label fatigue and remain unaware of the warning labels or disregard them. Moreover, warning labels are frequently removed by users or visually obscured during use or after installation. For these reasons, warning labels may not be performing their intended functions.

### BRIEF DESCRIPTION OF THE DRAWINGS

FIG. 1 is an isometric view of a container having a warning label in accordance with the prior art.

FIG. 2A is a partially schematic, isometric view of a container having a video warning system in accordance with an embodiment of the disclosure.

FIGS. 2B, 2C, and 2D are schematic illustrations of video screens configured in accordance with embodiments of the disclosure.

FIG. 3A is a partially schematic isometric view of a container having a video warning system configured in accordance with a further embodiment of the disclosure.

FIG. 3B is a partially schematic isometric view of a container having a video warning identifier configured in accordance with another embodiment of the disclosure.

FIG. 4 is a schematic isometric view of a mobile phone having a video screen for interacting with a video warning system in accordance with still a further embodiment of the disclosure.

FIG. 5A is a partially schematic illustration of a device having a video warning system configured in accordance with another embodiment of the disclosure.

FIG. 5B is a partially schematic illustration of the video warning system of FIG. 5A configured in accordance with a further embodiment of the disclosure.

FIG. 6A is a partially schematic illustration of a device having a video warning system including a data entry device configured in accordance with another embodiment of the disclosure.

FIG. 6B is a schematic illustration of a product manual having a video warning system configured in accordance with an embodiment of the disclosure.

FIG. 6C is a schematic illustration of an electronic reader having a video warning system configured in accordance with another embodiment of the disclosure.

FIG. 7 is a schematic illustration of a computing environment for implementing video warnings in accordance with an embodiment of the disclosure.

FIG. 8A is a schematic isometric view of an electronic device having a video warning system configured in accordance with an embodiment of the disclosure.

FIG. 8B is a schematic diagram of the video warning system of FIG. 8A.

FIG. 9 is a schematic isometric view of a communication apparatus having a video warning system configured in accordance with another embodiment of the disclosure.

FIG. 10 is a schematic flow diagram of a process for providing audio and/or video content to a user of an electronic device in accordance with an embodiment of the disclosure.

### DETAILED DESCRIPTION

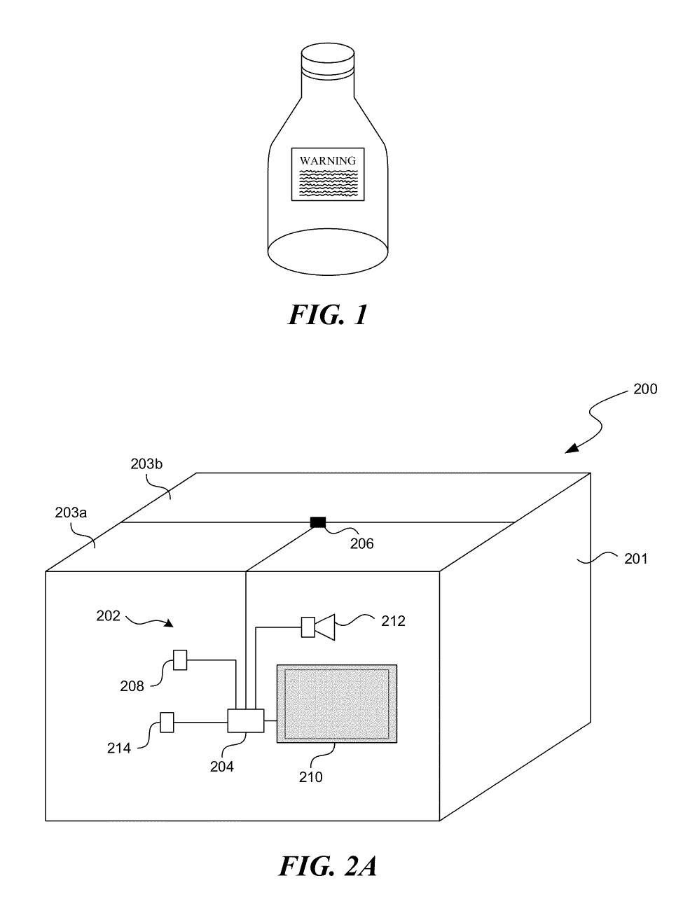

The following disclosure describes warning systems that display moving visual images, such as video images. Warning systems in accordance with the present technology can include warning and hazard information and may also contain instructions related to safety and safe and\or proper use. Videos (e.g., moving images or moving images and corresponding audio) that include such warnings, hazard information and/or instructions are referred to generally herein as video warnings or warning videos and can also be referred to synonymously by the term video warning label. Warning systems having such video warnings can be associated with various types of items, devices, containers, appliances, electronic devices, products, product packaging, and other objects. In one embodiment, for example, a container includes a video warning system to supplement or replace a printed warning label displayed on the container. Certain details are set forth in the following description and in FIGS. 1-6 to provide a thorough understanding of various embodiments of the invention. Other details describing well-known structures and systems often associated with warning labels, video systems, and associated components, however, have not been set forth in the following disclosure to avoid unnecessarily obscuring the description of the various embodiments of the invention.

Many of the details and features shown in the Figures are merely illustrative of particular embodiments of the disclosure. Accordingly, other embodiments can have other details and features without departing from the spirit and scope of the present disclosure. In addition, those of ordinary skill in the art will appreciate that further embodiments can be practiced without several of the details described below. Moreover, in the embodiments described herein and illustrated with reference to FIGS. 1-10 the containers, products, devices, etc. and various components are shown schematically for the purpose of illustration. Accordingly, and as will be appreciated by one of ordinary skill in the art, the various embodiments can include other structures and/or configurations than those illustrated in the Figures and are expressly not limited to the structures shown in the Figures.

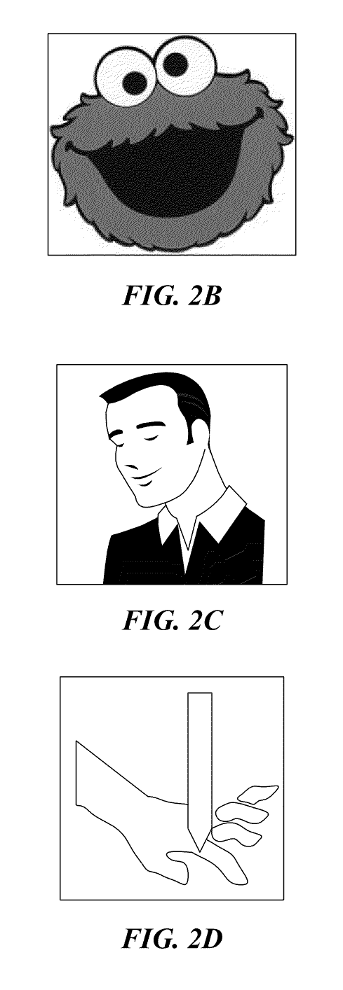

In the Figures, identical reference numbers identify identical, or at least generally similar elements. To facilitate the discussion of any particular element, the most significant digit or digits of any reference number refer to the Figure in which that element is first introduced. For example, element 202 is first introduced and discussed with reference to FIG. 2A.

FIG. 1 is a partially schematic, isometric view of a container having a warning label in accordance with the prior art. Conventional warning labels as shown in FIG. 1 are often in the incorrect language for a given user, can be difficult to read due to small font, or can otherwise fail to adequately warn a user of potential dangers. Additionally, traditional printed warnings often fail to attract the attention of a user, and/or are discarded or lost, thereby failing to provide the intended warning to a user.

Video warning systems in accordance with the present technology can include several features that help to overcome the inherent deficiencies of conventional warning labels. The video warning systems can be a pre-use and/or pre-event warning system that supplements or replaces both printed and audible warning labels now available and currently in use. For example, the video warning systems of the present disclosure can be used on various items, equipment, products and product packaging (boxes, cartons, containers, etc.). Hence, the video warning systems can supplement or replace printed and/or displayed written or audio warnings that are incorporated into products, attached to products, or included with the packaging of products, including the various supplemental materials that are often included with products. These supplemental materials are often prematurely discarded and no longer available, rendering the warnings and safety information unavailable.

FIG. 2A is a partially schematic, isometric view of a container 200 having a video warning system 202 in accordance with an embodiment of the disclosure. Several features of the video warning systems of the present disclosure can be at least generally similar to individual components and/or features of the audible warning systems in U.S. Pat. No. 7,772,986, which is incorporated herein by reference in its entirety. In the illustrated embodiment of FIG. 2A, the container 200 is a box. In other embodiments, the container 200 may be of a different shape or structure, and may be composed of a variety of materials. The video warning system 200 is carried by a container body 201 having closing members 203 (identified individually as first and second closing members 203a and 203b). The closing members 203 are pivotally attached to the body 201 to provide access to an interior portion containing a product (the interior portion of the body 201 and the product are not shown in FIG. 2).

The video warning system 202 includes a processor 204 (e.g., a controller, microchip, integrated circuit chip or video playback device, or any other component that can control a video playback function) operably coupled to a sensor 206 (e.g., a detector, switch, etc.), a computer readable medium or data storage medium 208 (e.g., memory, recording media, etc.), a video screen 210, a speaker 212 and a power source 214 (e.g., battery, solar cell, AC line power, electronic connector, fuel cell etc.). The processor 204 can be operably coupled to the sensor 206, the data storage medium 208, the video screen 210, the speaker 212 and the power source 214 with wireless, wired, fiber optic and/or other links to control operation of the video warning system 202. Although the video warning system 202 illustrated in FIG. 2A shows the components of the system operably coupled to each other, one skilled in the art will appreciate that some or all of the components of the video warning system 202 may be combined or included in a single component. For example, a video device can include a video card that includes a data storage medium incorporated on the video card. The video warning system 202 can be affixed to the container 200 by various methods, including, but not limited to, attaching it with adhesives, fasteners, etc., or embedding it within the container 200.

In operation, the processor 204 can cause the video screen 210 to display a video warning in response to a signal (e.g., an indication, notification, etc.) from the sensor 206. More specifically, the sensor 206 is carried by the container 200 and operably coupled to at least one of the body 201 and closing members 203 to detect movement of the closing members 203 from a closed position to an open position. In one embodiment, the sensor 206 can be a switch or contact including an electrical circuit path having electrical continuity when the closing members 203 are in the closed position. In this embodiment, the switch can be activated (initiating input to the processor) by interrupting the electrical circuit path and switching from continuity to non-continuity when the closing members 203 are moved to the open position. In other embodiments, the sensor 206 can include other devices that implement other methods of activation. For example, the sensor 206 can be a light sensor, a touch sensor, a biometric sensor, a temperature sensor, a proximity sensor, a motion sensor, etc. Additionally, other activation methods may be employed, for example, switches for product power on, touch screens, software switches, application start, device start, changes in volume or other usage, touch sensors, and other tactile means. Furthermore, the video warning system 202 can include multiple sensors 206 of the same or different types positioned at different locations on the container 200. Alternately or additionally, the video warning system 202 can be manufactured to be integral to the container or the item itself.

In addition to a video warning, the illustrated embodiment is configured to play an accompanying audio warning via the speaker 212. As with the video warning, the processor 204 can cause the speaker 212 to play the audio warning in response to a signal from the sensor 206. Although the illustrated embodiment includes a speaker 212 that is separate from the video screen 210, other embodiments may be configured to play accompanying audio through speakers that are integrated with the video screen 210. Additionally, still other embodiments may not include speakers, and may be configured to display video warnings without accompanying audio warnings. Accordingly, the terms “video warning” and “video warning system,” as used throughout the disclosure, include embodiments with, and without, accompanying audio. Additionally, the term “video warning” can be synonymous with the term “video warning label.”

The video warning can provide cautionary and/or safety information for anyone using or coming into contact with products, equipment, devices, items or their packaging, as appropriate. The cautionary information may include warnings about safe use and potential misuse and hazards associated with the product or device. One of the deficiencies in present warning label systems or literature is that users do not or cannot read them. There are also users that do not have the ability to read in the language that is displayed. The cautionary information in the video warning could be varied to prevent or reduce “warning label fatigue”, thus providing a better and more effective warning label.

The video warning systems and methods of the present disclosure can provide several benefits and/or include several features, such as: 1) providing a pre-event warning; 2) providing a standardized warning or alternating series of standardized warnings; 3) providing a warning message displayed in moving or changing pictures or other form of motion video; 4) coupling, directly or indirectly, to a device or item for which the warning is appropriate and/or necessary.

Present uses of warning labels are often ineffective for many reasons, including: users of the products who do not read the warning labels, labels that are discarded, labels that are unreadable or obscured, labels that become separated from the device so that subsequent users do not have access to them, or labels that contain the message in fonts that are too small or are in the wrong language. The video warning systems of the present disclosure reduce these limitations by using motion picture type video to announce the warning to the user.

The video warning can be a standardized safety message that is recorded on the data storage medium 208 by one or more of a manufacturer, marketer, wholesaler, distributor, retailer, or other interested party of a product or device, or by a related entity involved in the creation and/or distribution of the item. In some embodiments, the video warning is unalterable and the video warning system 202 is not configured to allow a user to change or reprogram the video warning. The video warning can include prerecorded safety information, such as a standardized warning related to the use of a product, can visually alert a user to a potential hazard before it occurs, and/or can supply other information to the user. Additionally, the video warning can be depicted such that it is universal, and overcomes language barriers inherent in written and verbal warnings. The video warning system 202 can also accommodate a wide variety of users, including for example, children, users that are illiterate or that have impaired sight, as well as users who speak languages other than English. Universal video warnings can include illustrations of proper and improper device usage, and utilize universal symbols or gestures to highlight the illustrations. For example, a video warning can include an actor demonstrating an improper usage while a large red “X” flashes on the screen.

The video warning systems of the present disclosure can make use of any form of changing or motion pictures, as appropriate, including: frame by frame revolving or changing images (including still pictures and series of still pictures), photographic depiction of hazards displayed individually and/or sequentially, depictions of hazards and how to avoid them, motion pictures, animated characters or movies, interviews, actors or recognizable celebrities acting out a script or talking directly to voice the warning, film footage of actual accidents or simulated accidents or other harm to the user, demonstration videos of how to avoid potentially harmful misuse, user responsibilities in the ownership and/or use of the device, and/or other motion picture methods. The video warning system can also be used to enhance a graphical display or textual based warning by displaying a warning label with larger fonts, multiple alternative languages, scrolling, and/or bouncing-ball-follow-the-text techniques. The warning message can differ from typical warning labels in that instead of textual, written or single iconic or pictorial warnings, the warning can be displayed by a video in which the potential hazards or harmful effects, or other injurious or destructive events that could result, are explained visually through moving visual images or any moving picture methods, including those described herein.

FIGS. 2B, 2C, and 2D are schematic illustrations of video screens configured in accordance with embodiments of the disclosure. Unlike existing warning labels attached to containers or products that are often ignored, video has a unique ability to attract attention, which written and verbal warnings do not have. Embodiments in accordance with the present technology can employ a variety of techniques to optimize the attention grabbing nature of video. For example, cartoon figures (as shown in FIG. 2B), attractive or attention getting people or items (such as the actor shown in FIG. 2C, or unusual items or unusual combinations of items), and/or humor can be used individually or in combination to attract attention to the video warning. Additionally, the video warning system 202 can convey a heightened sense of urgency regarding a warning of the use of the product. In some embodiments, for example, the video warning can convey emotion and vary the tempo of the delivery of the message to catch the user's attention. In still further embodiments, the video warning can show a graphic depiction of a potential harmful result of misuse of the product, such as that shown in FIG. 2D. These attention provoking techniques may be used to capture the user's attention, prior to displaying the video warning, even if the attention grabbing aspect is not related to the warning itself. Employing such techniques to gain a user's attention before or during the presentation of the warning can increase the effectiveness of the video warning system by reducing the possibility of the warning being overlooked, or missed.

Video warning systems in accordance with the present technology can include standardized warnings. Distinct from an end-use programmed warning, a standardized warning is typically meant for everyone in a certain classification of users, or others who may be in contact with, or otherwise interact with, the subject of the warning. Standardized video warnings have been played over broadcast media (television and Internet video). For example, standardized warnings can include the “interaction and side effect” warnings given by actors at the end of a prescription drug commercial, or the “drink responsibly and don't drink and drive” warnings given at the end of a television commercial for alcoholic beverages. The difference between general video warnings, such as those used in broadcast television commercials, and embodiments of the video warnings described herein, is that video warnings in accordance with the present technology can be directly or indirectly coupled to the individual specific item, device, container, appliance, or, product, and can be immediately available to the user, and relevant by the coupling. In some embodiments, the video warning system can directly couple a standardized warning to a device, product, or item, and play the warning automatically in a pre-use or pre-event fashion. For example, the video warning system 202 described above, and other similar embodiments, can play standardized warnings, and other warnings appropriate to the devices, products, and items, on a video screen coupled to the device (for example, a pill bottle or box in which the pill bottle came, or on a bottle or box in which alcohol is contained). The standardized warnings may include: a single video warning, multiple video warnings, rotating multiple video warnings, updated and varied video warnings, situational or use dependant warnings, or variations of the above. As will be described further below, the updated warnings can be made available by the manufacturer and downloaded or installed to the device by common means (internet download, computer coupled download to the item or device, memory card or stick, etc.). Additionally, the video warning can subsequently move from the standardized warning to a warning specific to an event or product triggering the warning.

The data storage medium 208 can include multiple video warnings, including, for example, as many warnings as a manufacturer chooses to record or program into the system. As such, the multiple video warnings could be displayed sequentially, randomly, or in any other order. Moreover, the data storage medium 208 can contain a video warning in two or more different languages. For example, the video warning system 202 can play a first video warning including text and/or accompanying audio in English, followed by a second video warning including text and/or accompanying audio in Spanish or any other language.

In another aspect of the embodiments of the disclosure, the data storage medium 208 can include other warning sounds, such as beeps, tones, chirps, buzzes or other alerting noises to supplement the video warning. As such, the speaker 212 can output or broadcast one or more alerting sounds before, during and/or after playing the video warning. The processor 204 can also cause the video screen to output or play the video warning a predetermined number of times in a specific time period. For example, the video warning system 202 can announce the video warning no more than five times a day or not more than one time each hour. The video warning system 202 can also be configured to play the video warning in response to an indication from the sensor 206 detecting the possibility of harmful action and alert the user before the action occurs. For example, if the video warning system 202 is associated with a container such as a pill bottle, and the user attempts to open the pill bottle more frequently than the prescribed interval between doses, the system can alert the user, for example, by playing a video that demonstrates the negative effects of taking more than the prescribed amount.

In further embodiments, the video warning system 202 can be a “smart” warning system. In such embodiments, the processor 204 can include logic or other programming to enable additional features associated with the video warning system 202. For example, different types of input from various sensors can be used to enhance the video warning system 202. If the sensor 206 is a temperature sensor, for example, it can activate the video warning system 202 if it detects a temperature that is outside a predetermined range. For example, if a container includes a product that should not be stored above a certain storage temperature, the video warning system 202 can alert a user to the potential detrimental effects of exceeding the storage temperature. Even though the trigger for the warning is related to the item that can cause a detrimental effect, it is displayed before the event intensity and duration has caused the detrimental effect (i.e. prolonged overtemperature, and is therefore still a pre-event warning.

In another aspect of the illustrated embodiment of FIG. 2A, the video warning system 202 can be configured to allow a user to select the language of accompanying audio or text for the video warning. For example, the video warning system 202 can include a switch or other input device that allows a user to select a language for accompanying text and/or audio. In other embodiments, the screen 210 can be a touch screen and/or have other input capability, such as attached buttons or switches to allow language selection. In still further embodiments, the video warning system 202 can include a microphone and speech recognition capability to allow a user to select a language. For example, a user can say “Espanol” and the video warning system 202 will display text and/or play accompanying audio in Spanish. After a language has been selected, the language can be used in the video warning to provide spoken language that accompanies the video and textual captions that describe the information during the video. The textual language can include scrolling text on the bottom of the screen or interruption of a video segment with bold lettering stating CAUTION or HAZARD to grab the viewer's or user's attention. In another embodiment, a microphone can be operably coupled to the processor 204 to detect languages that have been spoken just prior to playing the video warning, and the video warning can be played in all relevant languages.

The video warning system 202 and others disclosed herein can also include an activation feature that requires activation (e.g., pressing a button or removing a tab) before the video warning system 202 will function. The video warning systems 202 can also include a test feature such that a user could activate the video warning system 202 with the test feature (e.g., by pressing a button) without actually using the object associated with the video warning system 202. For example, a user may test the video warning system 202 carried on a container without opening the container to determine if the video warning system 202 is working.

The video warning system 202, and other warning systems disclosed herein, can be configured with still further additional features. For example, in certain embodiments the video warning system 202 can have a user disable feature to disable or silence the system after the video warning has been broadcast one or more times. The user disable feature can be configured such that the video warning system can play a warning different from the standard warning to alert the user to the danger of disabling the video warning system 202. For example, the video warning system 202 can alert a user that using the disable feature is at the user's own risk. In some embodiments, the video warning system can automatically disable or silence after the video warning has been broadcast one or more times. The video warning system 202 can also include a biometric sensor to detect when a different user is using the object associated with the video warning system 202. The video warning system 202 can accordingly be configured to play different video warnings for different users detected by the biometric sensor. In still further embodiments, the video warning system 202 can include a motion sensor (e.g., a Global Positioning System (GPS) sensor or gyroscope) to detect movement of the video warning system 202 and play the video warning if an object carrying the video warning system 202 is moving above a predetermined speed.

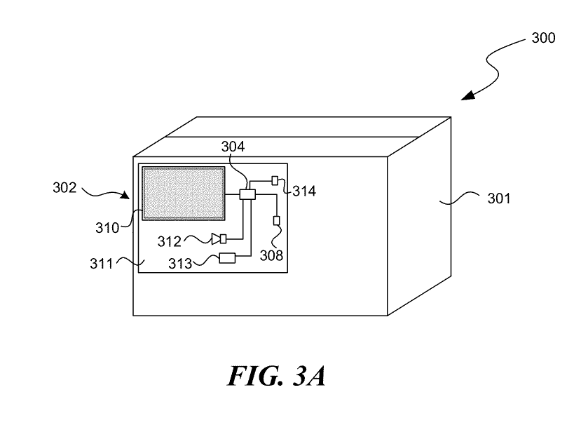

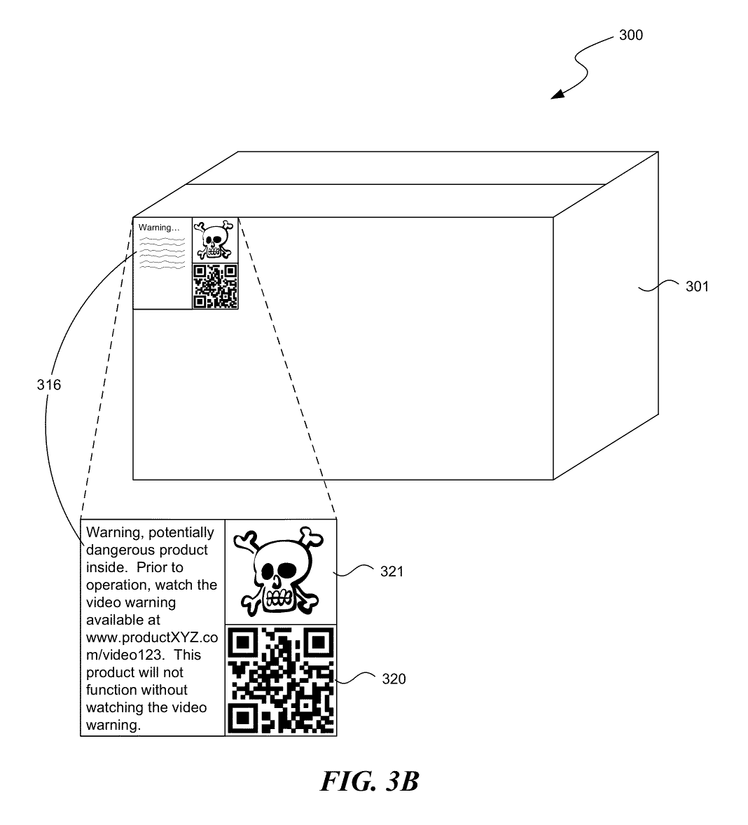

Video warning systems configured in accordance with the present technology can include video warning labels that can be attached to products, product containers or packaging, and/or product manuals, such as user manuals, in a variety of ways. In some embodiments, video warning systems can include a label that includes a video screen. FIG. 3A, for example, illustrates a partially schematic isometric view of a container 300 having a video warning system 302 configured in accordance with a further embodiment of the disclosure. In the illustrated embodiment, the video warning system 302 includes a substrate, base, or housing 311 attached to a body 301 of the container 300. The housing 311 includes a video screen 310 that is operably coupled to a processor 304. In some embodiments, the video screen 310 can be a touchscreen. A speaker 312, a data storage medium 308, a power source 314 and an activation device 313 can be operably coupled to the processor 304. The activation device 313 can include an active or passive switch, sensor, or another suitable component that can generate a signal to initiate a video warning in a manner at least generally similar to that described above with respect to FIG. 2A. In some embodiments, for example, the activation device 313 can be implemented via hardware and/or software. For example, a software application can present a manual activation device on the video screen 310 (e.g., in the form of a button or switch on the touch screen or video screen 310). The housing 311 can be a thin device that can house all of the components (e.g., the video screen 312, the data storage medium 308, etc.) and can be easily affixed to the container 300. For example, in some embodiments, the housing 311 can include a laminated material (e.g., a paper product) that provides an overall thickness for the video warning system 302 of less than one centimeter. In other embodiments, the overall thickness can be one centimeter or more. Additionally, although the illustrated embodiment includes a housing 311 having a footprint that is larger than the video screen 310, in other embodiments, the screen 310 can have a footprint of the same or a similar size as the housing 311.

The video warning system 302 can operate in a manner at least generally similar to the video warning system 202. For example, the processor 304 can cause the video screen 310 to display a video warning in response to a signal (e.g., an indication, notification, etc.) from the activation device 313. In some embodiments, this can include a user interacting with the activation device 313 (e.g., pushing a button or toggling a switch on the activation device 313) to generate the signal. In some embodiments, written instructions can direct a user to interact with the activation device 313 to initiate a video warning.

The warning video can also be indirectly coupled to the specific items, devices, containers, appliances, electronic devices, products, product packaging, and other objects. FIG. 3B is a partially schematic isometric view of the container 300 having a video warning identifier 316 configured in accordance with another embodiment of the disclosure. The video warning identifier 316 is attached to the body 301 of the container 300. In the illustrated embodiment, the video warning identifier includes textual information 318 and a Quick Response (QR) code 320. The textual information can include information regarding the hazardous nature of a product within the container 300 and information regarding a video warning. For example, as illustrated, the text can include the statement: “Warning, potentially dangerous product inside. Prior to operation, watch the video warning available at www.productXYZ.com/video123. This product will not function without watching the video warning.” Additionally, the QR code 320 can include an embedded link that can be read by a mobile or smart phone having a camera, as described in more detail below. The video warning identifier 316 can further include a visual depiction to supplement the textual information 242. The visual depiction can include, for example, a skull and crossbones 321, which are frequently used to indicate danger.

In addition to the instructions provided by the textual information 318 and the electronic instructions provided by the QR Code 320, video warning identifiers in accordance with the present technology can include other textual or electronic instructions that direct or activate devices to display video warnings. For example, indirectly coupled video warnings can also be activated by Radio Frequency Identification (RFID), Near Field Communication (NFC) or other encoded proximity sensors with identifiers, such that the video display screen automatically displays a video warning when in proximity to the item. Alternately, it can pop-up a question, requesting permission to stream or download the video warning and play it for the user.

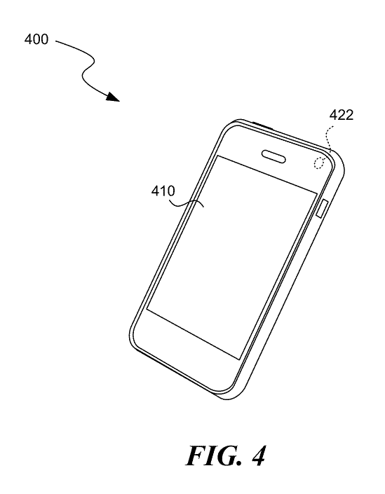

FIG. 4 is a schematic isometric view of a communication device, or smart phone 400 having a touch screen or video screen 410 for interacting with a video warning system in accordance with a further embodiment of the disclosure. In the illustrated embodiment, the smart phone 400 includes a camera 422. Referring to FIGS. 3B and 4 together, a purchaser of the product within the container 300 can use QR reading software on the phone 400 and the camera 422 to read the QR code 320. The QR code 320 can direct the phone to a web address for a video warning. The video warning can include a code that must be entered into the product to allow operation, as described further below.

In some embodiments, the camera 422, and/or other cameras or optical/visual imaging devices, can be used with recognition software. The recognition software can use optical character recognition to read text on an object to identify the object, e.g., identify a general type of object and/or identify a specific brand and/or model. For example, the optical character recognition can read the word “bleach” or can read an actual brand name for the bleach. If the word “bleach” is recognized, the software can then direct the phone to a web address to play a video warning related to bleach in general. If the manufacturer or brand of bleach is recognized, the software can direct the phone to a web address from the manufacturer of the bleach to play a warning video made by that manufacturer for that specific blend and type of bleach.

Alternately, or additionally, the recognition software can use other visual recognition techniques including shape, color, and\or comparisons of the image of the item taken by the camera to other images or photographs in a database. Using the visual recognition techniques, the software can detect the type of object, and\or the manufacture and model of the item or device. The software can then direct the phone to a web address to play a video warning related to the general class of device, or the actual model of the device.

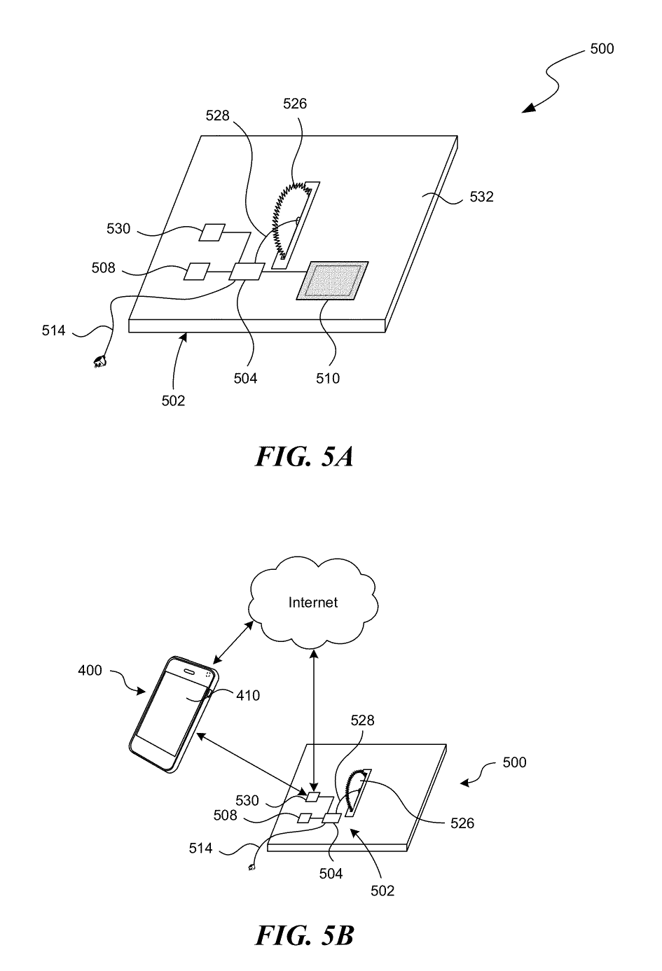

FIG. 5A is a partially schematic illustration of a device or table saw 500 having a video warning system 502 configured in accordance with another embodiment of the disclosure. The table saw 500 includes a base 532 and a saw 526. As with the video warning system 202, the video warning system 502 includes a processor 504, a power source 514, a video screen 512, and a data storage medium 508. The video warning system 502 also includes a communication device 530 and a connecting line 528. The communication device 530 can be a Bluetooth, Wi-Fi, or other wired or wireless device that allows the video warning system 502 to communicate with other devices to transmit or receive information. For example, the communication device 530 can communicate with a network to download new or updated warning videos. The communication device 530 can include antennas, processors, electrical circuits, and/or other suitable components for receiving, transmitting, and/or processing signals. In the illustrated embodiment, the connecting line 528 is configured to provide power to the saw 526 through the processor 504. The video warning system 502 can be configured to only provide power through the connecting line 528 after a video has been viewed on the video screen 512, or an external video screen. This can be implemented through the display of a code during the video that must be entered into the device, or by giving a short quiz requiring the correct answer prior to enabling the use of the device or appliance.

In some embodiments, the video warning system 502 may not include a video screen 512, and the communication device 530 can communicate with another device, such as the smart phone 400 to confirm that a video has been watched. FIG. 5B is a partially schematic illustration of the video warning system 502 configured in accordance with a further embodiment of the present disclosure. In the illustrated embodiment, the video warning system 502 includes the processor 504, the power source 514, the data storage medium 508, the communication device 530 and the connecting line 528. However, in this embodiment, the video warning system 502 is in communication with the smart phone 400 for display of a video warning on the video screen 410. The video warning system 502 can transmit videos stored in the data storage medium 508 to the smart phone 400, or can direct the smart phone 400 to a video that can be accessed via the internet. Additionally, the video warning system 502 can download additional videos, software updates, or other information or data from the internet.

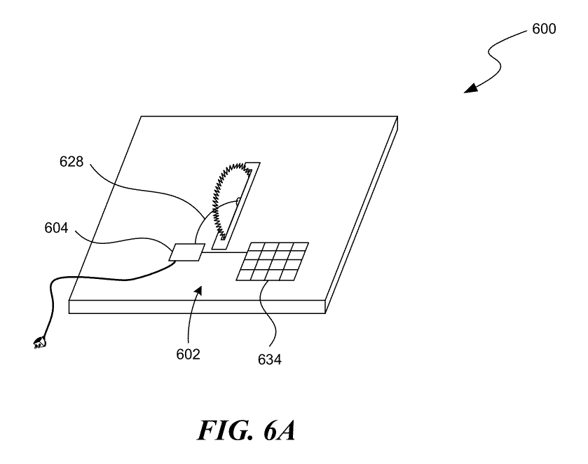

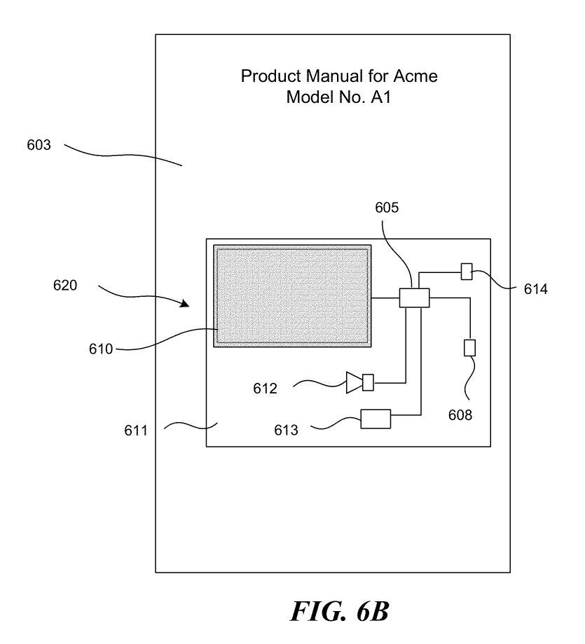

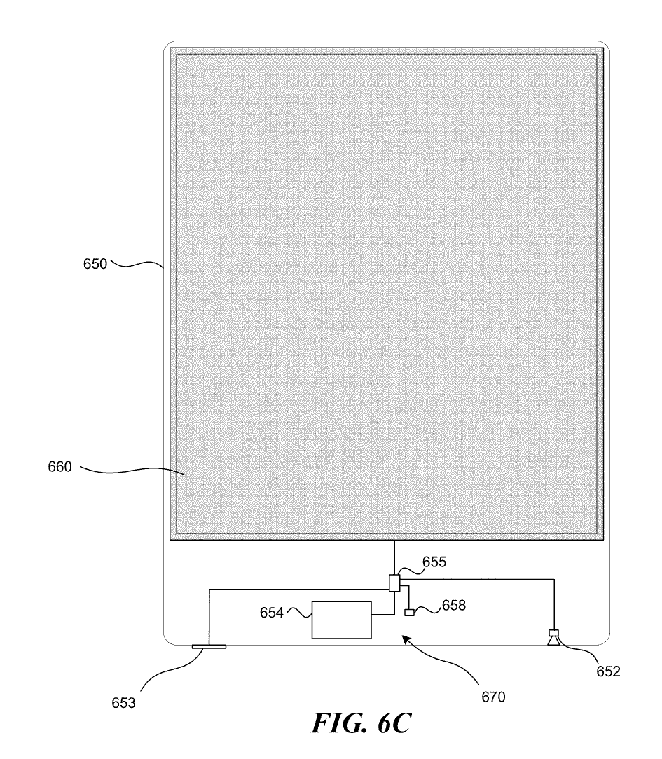

FIG. 6A is a partially schematic illustration of a device or table saw 600 having a video warning system 602 having a processor 604, a data entry device or keypad 634 and a connecting line 628 configured in accordance with another embodiment of the disclosure. In the illustrated embodiment, the video warning system 602 does not include a video screen. However, video warnings associated with the table saw 600 can be watched on alternative devices, such as the smart phone 400. The video warning system 602 can be configured to only provide power through the connecting line 628 after a specific code has been entered into the keypad 634. The code can be provided within or at the end of a video warning that a user is directed to. For example, the table saw could be provided to a user inside the container 300, with the video warning identifier 316 directing the user to the appropriate video warning. After linking and playing the video warning and\or logging the playing thereof, the video warning system 602 can play additional videos such as instructional material, operating and maintenance instructions, tip of the day, and other related material.

As shown in the figures discussed above, video warnings in accordance with the present technology can be played on screens inherent in a device, such as in the smart phone 400 or other handheld electronic devices. Also described above, video warnings can be played through a video screen that is added to a device or to product packaging, such as the container 300. Video screens in accordance with the embodiments of the present technology can include any of the available screen technologies, including LCD, LED, thin film, electronic ink, and other video displays.

As discussed above, in some embodiments, video warnings can be played on an external video device, either directly or indirectly coupled, to a device, product, or item. The video warning system can also utilize exterior screens not specifically or solely made for the purpose of giving a video warning. For example, a single video display can be used to display the warning message for multiple devices. Such a multiproduct video warning system can include an input as to the device or product for which it will display the warning, either by manual entry or various other means (voice, touch screen, typing, etc.) or by reading a bar code, RFID chip, QR code, graphical tag, NFC, or encoded proximity sensor or other identifier on the device or packaging. By using an indirect coupling method, a user can watch product specific video warnings. A multiproduct interface can make video warnings available to products or devices that do not have a video screen readily available. The screen can be any video display with a programmable interface, e.g., smart phones, other handheld electronic devices, electronic tablet computers, laptops, programmable interactive televisions, etc. An initiator (e.g. manufacturer) can configure the products or devices such that identifying the device or product (e.g., through the bar code or reading the RFID code) and playing the video warning is mandatory before the item could be used or accessed, as described above. Alternatively, the initiator can make playing the video warning a recommended step, and/or limit the use of the device until the video warning is played and acknowledged. Systems of the present disclosure can be configured in any number of ways to verify that the user has viewed a video warning. As above, indirect coupling methods can use unique ID codes given at the end of the video warning, such that the user must enter the code into the device to allow operation. In other embodiments, Bluetooth or other wireless signals can transmit to the device an affirmation that the video warning has been played by the user. Other verification and means can be used to provide enforcement of the viewing of video warning labels.

Although FIGS. 5A-6A illustrate specific embodiments of a user-operable device or appliance, the present disclosure is not limited to video warning systems associated with only the illustrated embodiments. Rather, the video warning systems and associated video warnings described herein can be used with numerous different types of objects, devices, apparatuses, equipment, assemblies, appliances and the like, including both non-powered and powered objects. For example, these systems can be used with, but are not limited to, home and personal appliances (e.g., kitchen appliances, heating appliances, cookware, coffee makers, toasters, cutting and food processing appliances, mixing appliances, vacuums, polishing and cleaning equipment, refrigerators, freezers, disposals, cook-tops, ranges, stoves, ovens, microwave ovens, water heaters, trash compactors, dishwashers, sewing machines, massage equipment, toothbrushes, razors, shaving equipment, battery chargers for cordless appliances, etc.); heating and ventilation equipment (e.g., portable and stationary heaters, fans, air conditioners, central heating and air conditioning systems, etc.); industrial and process equipment (e.g., machine tools, milling machines, conveyors, processing equipment, air compressors, valves, welding equipment, turbines, pumps, motors, engines, generators, etc.); outdoor appliances (e.g., barbecues, grills, radiant heaters, lawnmowers, blowers, trimmers, clippers, edgers and other lawn and garden equipment, etc.); outdoor equipment (e.g., camping, hiking, backpacking and survival equipment, hang gliders, parachutes, playhouses, swings, swing sets, children's outdoor gyms, climbers, slides, trampolines, hot tubs, whirlpools, fountains, wading pools, slip-n-slides, swimming pools, etc.) manual and power tools (e.g., circular saws, miter saws, drills, routers, sanders, joiners, planers, painting equipment and sprayers, nail guns, staple guns, riveters, screwdrivers, welding equipment, torches, soldering equipment, polishers, heat guns, glue guns, etc.); household and commercial furnishings and fixtures (e.g., plumbing and electrical systems, electrical products, lighting, lamps, furniture, etc.); baby, infant and toddler care products (e.g., strollers, cribs, walkers, jumpers, swings, mobiles, car seats, infant seats, diapers, lotions, powders, etc.); office products and equipment (e.g., paper shredders, copy machines, computers, printers, paper cutters, etc.); exercise equipment and sporting goods (e.g., guns, knives, hatchets, axes, archery equipment, treadmills, cross trainers, stair climbing machines, stationary and non-stationary bicycles, resistance training machines, free weights, stretching equipment, scales, etc.); alternative transportation (e.g., all terrain vehicles, motorcycles, boats, personal watercraft, scooters, skateboards, etc.); and automobiles (e.g., cars, trucks, sport utility vehicles, vans, motor homes etc.); heavy industrial equipment (e.g. forklifts, front end loaders, dump trucks, backhoes, etc.). The above identified examples are intended to be merely illustrative and in no way exhaustive of the types of devices and apparatuses that would benefit from the video warning systems disclosed herein. Additionally, although several embodiments of the present technology are described herein with reference to a particular product, a container, packaging and/or supplemental material included with a product, use of the term product herein can include any of these items and/or other items, including those described above.

As discussed with respect to the table saw 500, video warning systems in accordance with the present technology can include transmitting the video warning for a device to a remote screen for display. The video warning can be stored in the device, while the user's personal video display (handheld electronic device or other video screen) or other external or alternate video display is used to display the video warning. That is, the device for which the video warning is displayed can also transmit the video warning to the remote screen. In this case, the video file itself can be resident in the device, while the user's personal video display (handheld electronic device or other video screen) or other external or alternate video display is used to display the video warning label. This, and other methods can be used to store and transmit the video warning to an exterior video playback device, without relying on the Internet. Communication between devices can use any available medium, including various wired and wireless methods. Alternately, the device may simply transmit the URL of the location of the video warning on the internet, or other identifier code to the external video display to enable it to display the proper video warning, where ever the video warning is stored. The video warning can also be streamed from the Internet to the device or downloaded to the device from the Internet. In a video warning system configured to stream or download video, the device can communicate its identifier to the indirectly coupled video display, which then will stream or download video that includes or consists of the video warning. Video warnings that can be downloaded or streamed from the internet can allow the manufacturer or other interested party to keep the video up to date, including providing product recall notices, if any. In some embodiments, a device or product can be remotely disabled until an updated video warning has been viewed. For example, a signal can be sent to the communication device 530 in the video warning system 500 (FIG. 5A, 5B) that can prevent power from being supplied to the device until an updated video warning has been viewed.

In a further aspect of the present technology, an electronically interconnected home or business can have a network (wired or wireless) of devices that communicate to a central device with a video display or multiple devices with video display(s). These devices which display the video warnings for the products, devices, and other items in the home and/or business can play the video warnings at the appropriate time(s), in advance of use, or prior to the potentially hazardous type of use, as described herein. For example, in the business application of the video warning, a single networked or internet connected handheld video screen would be used by technicians, mechanics, operators, and others, to play video warnings for whatever equipment or devices they were going to operate, maintain or repair.

The video warnings described herein can be pre-event warnings that are available prior to a product or item's use, or prior to the phase of use of a product or an event that could conceivably cause a deleterious or otherwise harmful or potentially destructive, damaging, hurtful, or undesired event. For example, the video warning systems of the present disclosure can be configured to play a video warning every time a device is turned on. Alternatively, in the case of an application on a cell phone that provides turn-by-turn directions via GPS, a video warning can be played when the application is activated, or when the device or application is activated and the device starts moving. In all of these examples, the video warnings are pre-event warnings. In the case of the GPS and driving example, the car has not already crashed to cause the warning. When acted on by a user, the pre-event video warnings of the present technology can be preemptive of harmful effects, as opposed to post-event warnings now in use. For example, an audio warning that states, “door ajar” when a car has already started moving and a door is not completely closed is a post-event warning.

Video warning systems in accordance with the present technology can supplement or replace printed warning labels or textual displays of warning labels that are now included or might be needed on products, consumer electronic devices, handheld electronic devices, fixtures, equipment or machinery. The video warning systems can also supplement or replace audio warnings that may be included. Existing written and graphical warning labels can only show text and/or a single or limited number of photographs, sketches or other warning cautionary information. Video warnings do not suffer these limitations. The pre-event video warnings described herein are superior in their ability to alert users before accidents or other harmful or deleterious events occur.

Many existing devices do not presently have warning labels because the warning is only applicable to the device when used with a certain application, but not to the device in general. For example, handheld electronic devices can have multiple uses (telephone, GPS navigation, music player, internet browser, etc.). In many cases, some, but not all of these uses can require a warning message prior to use. A device having such a multitude of uses cannot readily display all the different warnings that are needed for various applications. For example, a warning related to hearing loss and excessive volume may be needed for the music player, while a warning related to not entering addresses while driving may be needed for a GPS unit or for a device running a GPS navigation application. It is impractical to print these warnings and place the textual based warnings on the outside of the case of the device, both because the device surface area is not large enough to display them all, and they could aesthetically degrade the device. In the case of standard written warning labels, the label can be obscured or the warnings with the packaging and owners manual can be lost. Conversely, in the case of video warnings, the warning can stay with the product over the entire product life, and can be updated over the life of a product. Additionally, context specific video based warnings can be played on the handheld device screen itself, either prior to the application starting, or prior to the event that could cause harm. Multiple triggers may be set which can invoke the video warning system. For example, in the music player application, the video warning related to potential permanent hearing loss due to prolonged excessive volume could be played automatically prior to the music player starting, or when the volume is turned up past a predetermined level. In the latter case, the device can be configured to first pause the music, then play the video warning, and, after the playing thereof, allow the user to turn the volume higher.

Many devices, tools, appliances and other items are sold with a specific product manual included. The video warning can be applied to this manual to make the safety information more understandable, make the language adaptable, and make the video warning more likely to be viewed by the user than written material. In one embodiment, a product manual can include an integrated screen with video playback capabilities. For example, a video warning system at least generally similar to that described above with respect to FIG. 2A or FIG. 3A can be integrated or attached to a product manual. The integrated screen can be used to play product safety information to the user. FIG. 6B is a schematic illustration of a manual 603 (e.g., a product manual, user manual, operating manual, maintenance manual, etc.) having a video warning system 620 configured in accordance with an embodiment of the present technology. In some embodiments, the product manual 603 can be a paper product manual that can be provided to a consumer with the product. In the illustrated embodiment, the video warning system 620 includes a substrate, base, or housing 611 attached to the product manual 603. Similar to the video warning system 302 of FIG. 3A, the video warning system 620 includes a processor 605 and several components operably coupled thereto. For example, in the illustrated embodiment, a display screen or video screen 610, a data storage medium 608, a speaker 612, an activation device 613 and a power source 614 are operably coupled to the processor 605. In operation, the video warning system 620 can function in a manner at least generally similar to the video warning system 302 of FIG. 3A, with the activation device 613 providing a signal for the initiation of a video warning. In some embodiments, a video warning can be broadcast in response to removing the manual 603 from a bag or other container. Moreover, confirmation of viewing of the video warning may be required in some embodiments before the associated product, equipment, etc. can be used.

In some embodiments, an electronic paper reader (e.g., an e-reader or other mobile electronic device for reading digitized written material) can be used to display the manual and the warning video. FIG. 6C, for example, is a schematic illustration of an electronic reader 650 having a video warning system 670 configured in accordance with an embodiment of the present technology. The video warning system 670 can be at least generally similar in structure and function to those described above with respect to FIGS. 2A-6B. For example, the video warning system 670 includes a processor 655 and a video screen 660, a data storage medium 658, a speaker 652, an activation device 653 and a power source 654 operably coupled to the processor 655. electronic readers and other video playback devices configured in accordance with the present technology can also use indexing, logging, and/or other suitable means to remember videos that a specific user has previously viewed, so that the device only plays alternate videos that the user has not viewed yet.

Additionally, the product manual and an associated video warning can be completely stored electronically or digitally, such that no physical manual is needed. A soft copy digital form of an electronic product manual and an associated video warning for a device can be stored in the memory of a personal computer, an ereader, or another suitable computing device. The electronic manual and/or the video warning can be updated via the internet or other memory storage and data transfer method. The video warning can be played automatically or manually selected and initiated.

The product manual can also be entirely stored on the internet, where the video warning for the product can be played when the product manual is accessed from the internet. The unique inclusion of the video warning can heighten the awareness of the user, as the warning is associated with the specific product for which the manual is being accessed.

While the video warnings of the present disclosure are typically displayed before the use of a product or device, they can also be displayed after use, but before a potentially harmful event occurs. For example, when turning up the volume on a music player past a normally safe level, the video warning system can engage and play a moving video clip of a musician that has lost his hearing due to prolonged exposure to loud music. Alternatively, a table saw with the video warning system can play a video warning on a video screen depicting the hazards associated with the use of the saw—before the saw blade starts. While in one case, the warning is played before the device's main feature starts, in the other case; the warning is played after the device has started, but before the potentially hazardous event occurs. In any case, the video warning system is a pre-use or pre-event warning that is issued before the accident, harmful event, or damaging event has occurred.

Video warning systems in accordance with the present technology can be updated by a manufacturer or other party, either through a direct internet or network interface, or via plug in memory cards of various available types. Ethernet, wireless cards or connections, Wi-Fi, Bluetooth, and other communication methods and mediums that may be available or in use can be incorporated into the video warning systems of the present disclosure. The memory cards can be updated by the manufacturer and sent to the users, or distributed through other means. Alternatively, the user can update the device or memory cards via separate internet download to the memory card, then plug the memory card into the device for which a video warning update is needed or desired. Additionally, these updates can be done automatically, with no user intervention. Furthermore, users, manufacturers, and other parties can make full use of available internet technologies, means of communication and, other uses with the video warning system. Such uses can include social networking internet sites, personal web pages and blogs, company web pages and blogs, and any other internet means to enhance the communication, transmission, implementation, and use of the video warning systems.

Internet means can be used to store, update, view, share (from company to consumer, business to business, and person to person), notify, register, and log the video warning system, including acknowledging the availability, and/or viewing of the video warning system and other manufacturer's or other parties data. For example, a user can log into a social network site where manufacturers offer viewing, streaming, or downloading of video warnings. The suppliers and users of video warnings can use any of the available means of identification and communication, including bar codes, design codes, and other unique alphanumerical or graphical (or combined alphanumerical and graphical) means to match the video warning identifier associated with their product or item to the proper video warning from the manufacturer or other party. This includes optical scanning, barcode reading, QR code scanning/recognition/reading, other graphical recognition methods, alphanumerical, NFC, encoded proximity sensors, RFID chips and other identification and transmission of identification techniques.

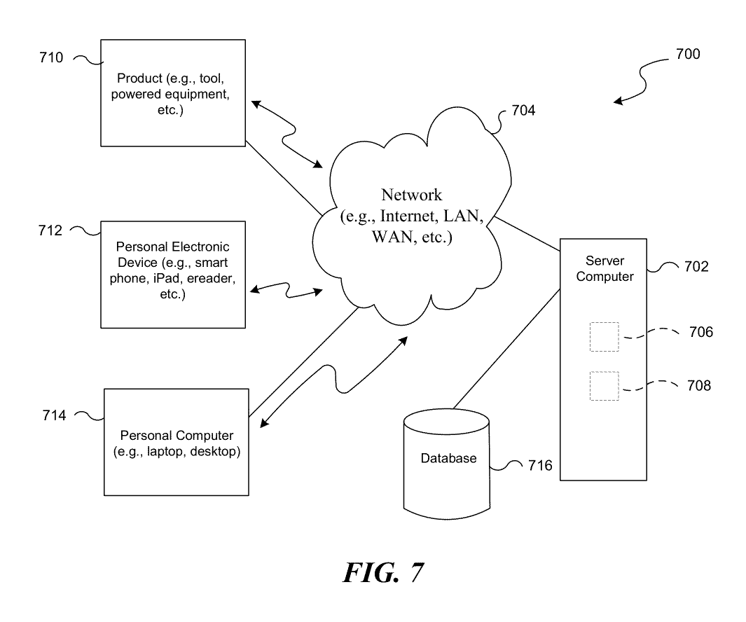

Video warnings in accordance with the present technology can be practiced in a variety of computing environments. For example, FIG. 7 is a schematic illustration of a computing environment for implementing video warnings in accordance with an embodiment of the present disclosure. In the illustrated embodiment, a video warning system 700 includes a server computer 702 coupled to a network 704 (e.g., the Internet, a LAN, a WAN, or other suitable network, including web sites, ftp sites, live feeds, and data repositories within a portion of the network 704). The server computer 702 can include a processor 706 and a data storage medium or computer readable storage medium 708 (e.g., memory, recording media, etc.). The computer readable storage medium 708 can contain video warnings that can be accessed by or otherwise provided to a plurality of, products, consumer electronic devices and/or other devices that can connect to the server 702. For example, a product 710 (e.g., the tablesaw 500 or another product, tool or device) or a personal electronic device 712 (e.g., the smart phone 400) can connect to the server computer 702 through a wired or wireless connection to the network 704. The server computer 702 can provide video warnings contained on the computer readable storage medium 708 to the product 710 and/or to the personal electronic device 712. Additionally, video warnings can be provided to a personal computer 714 (e.g., a laptop or a desktop). For example, a web address for a video warning can be provided to a consumer on a warning label and/or in another manner (e.g., in a user manual, via a QR code, etc.). The product 710, personal electronic device 712 and/or the personal computer 714 can be directed to the web address, and the server 702 can provide the video warning to the consumer through the network 704. In some embodiments, a database 716 can be coupled to the server computer 702. In a manner at least generally similar to the computer readable storage medium 706, the database 716 can store video warnings and/or other information related to the video warning system 700.

In a further aspect of the present technology, users can use social networking, personal networking, and various personal and company web pages in public and/or private databases to log their viewing of video warnings. While the user can type information into a website form, the website can also use voice recognition of the user's verbal input to log these viewings. The website can also record the user's verbal response or input for later verification, including voice identification techniques. In some embodiments, the users can then “collect” certificates of viewing of video warnings. For example, the certificates could be given by a company once a user has viewed a video warning and registered and/or answered a question or provided other information related to the video warning to verify viewing. The certificates can include special company design logos issued by the company and unique to their product or device. Companies can also offer credits, coupons, discounts, gift certificates, or drawings for prizes or other inducements for users who log their viewing of video warnings or collect the certificates and/or users who share video warnings with others (friends, family, and internet acquaintances). Viewing of video warnings for products, devices, equipment, and other appropriate items that a person has or uses can be an accomplishment to be shared and encouraged. Companies can use a video warning registration process to notify or alert users to new video warnings related to their product or items, as well as notifying them of related video and informational material. The internet can also be used in its various forms as collecting places for video warning references and product user groups, and also video warning safety advocacy and user groups. Computer executable instructions for implementing video warning systems and/or portions of video warning systems configured in accordance with the present technology can be stored and operated on one or more server computers 702 and/or other suitable processing devices. For example, the computer readable storage medium 706 on the computer server 702 can contain computer executable instructions that register users, record viewing activity, award certificates and/or perform various other suitable functions associated with video warning systems in accordance with the present technology.

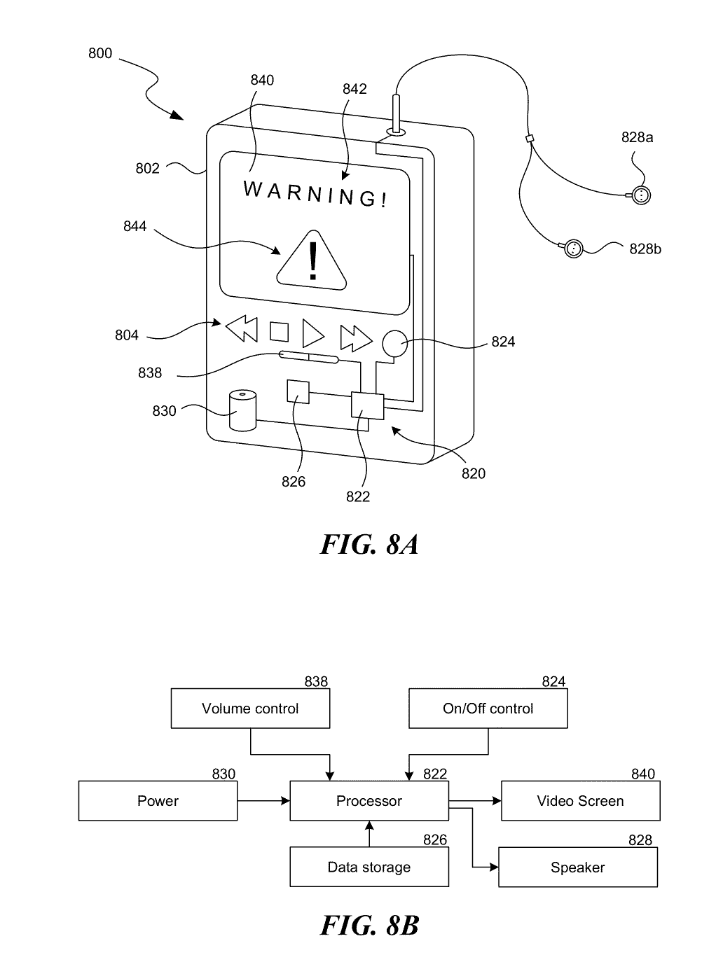

FIGS. 8A-10 illustrate various embodiments of video warning systems incorporated into devices having pre-existing video playback capabilities. The software and/or processing components of such devices can be configured to output a video warning when one or more predetermined criteria have occurred or been satisfied (e.g., the device has been turned on, a particular application is opened or is running on the device, the device is audibly broadcasting at or above a certain sound level, and/or other suitable criteria). FIG. 8A, for example, is a schematic isometric view of an electronic device 800 having a video warning system 820 configured in accordance with a further embodiment of the technology. FIG. 8B is a schematic diagram of the video warning system 820 of FIG. 8A. Referring to FIGS. 8A and 8B together, the illustrated device 800 is a portable media player (e.g., a music and/or video player) having a body 802 that carries the video warning system 820. The device 800 also includes various user input buttons or controls 804 for controlling the device, and a video screen 840 for presenting or displaying video content. Although the illustrated device 800 includes user input controls 804 separate from the video screen 840, in other embodiments the video screen 840 can include a touch screen that can provide icons and/or other features for receiving user input. The device 800 further includes speakers 828 (identified individually as a first speaker 828a and a second speaker 828b). In the illustrated embodiment, the speakers 828 are earphones. In other embodiments, however, the device 800 can include one or more speakers permanently attached to the body 802.

The video warning system 820 of FIGS. 8A and 8B can be generally similar in structure and function to the video warning systems described above. For example, the video warning system 820 can include a processor 822 operably coupled to each of an on-off control 824, a data storage medium 826, the speakers 828, a power source 830 and the video screen 840. The data storage medium 826 can contain video content and/or audio content, and can include a video warning relating to use, assembly, transport, etc. of the device 800. For example, when a user turns on the device 800, the video warning system 820 can display the video warning on the video screen 840 and play accompanying audio content on the speakers 828. In a manner at least generally similar to that described above with respect to FIGS. 2A-7, the video warning system 820 can be configured to prevent operation of the device 800 until the video warning has been viewed.

In some embodiments, the video warning in the data storage medium 826 can include textual information 842 and/or graphical information 844 relating to use of the device 800. For example, when the device 800 is activated, the display 840 can present the textual and/or graphical safety information 842, 840 to a user prior to, as part of, or after display of the video warning. Additionally, audio content of the video warning can correspond, at least in part, to the textual information 842 and/or to the graphical information 844.

In another aspect of this embodiment, the video warning system 820 can include a volume control 838 operably coupled to the processor 822. The volume control 838 can increase or decrease the volume of sound output by the speakers 828a, 828b. In certain embodiments, the video warning system 820 can output a video warning in response to a specific sound level. For example, if a user adjusts the volume to a predetermined sound level, the video warning can be displayed and accompanying audio can be played through the speakers 828 (e.g., “Warning! Prolonged listening at this volume level may cause hearing damage.”). The video warning can also include safety information relating to different uses of the device 800.

One benefit of this embodiment is that some of the components of the video warning system 820 can be components that are already part of the device 800. For example, the data storage medium 824 can include the video warning in addition to sound and video content associated with the device 800. Moreover, the video screen 840 can display the video warning in addition to outputting other video content (e.g., music videos, movies, etc). Similarly, the first and second speakers 828a, 828b can be used to announce audio content of the video warning in addition to outputting music or other sounds to a user. Furthermore, the power source 830 can include a rechargeable battery to provide power to the device 800 such that the video warning system 820 does not require a separate power source. Accordingly, in certain embodiments the software and/or programming of the electronic device 800 can include instructions to output the video warning using the pre-existing hardware and/or other video and sound playback capabilities of the device 800. For example, the device 800 or others described herein may include a computer readable medium containing instructions causing the device to play the video warning as well as other video and/or audio content associated with the device 800.

Another benefit of this embodiment and other embodiments described herein is that the video warning system 820 can visually output a video warning to a user where no warning label may be originally associated with an object. Cell phones, portable music players, and many other objects, for example, may be too small to display a warning label. Warning labels may also be undesirable on these types of objects for aesthetic reasons. Accordingly, the video warning systems disclosed herein can provide safety information associated with an object that is not displayed on the object. For example, in certain embodiments the video warning system can include information that is included in a user's manual associated with the object. Accordingly, the video warning system can alert a user to information included in a user manual or other supplemental text that a user may not read or even be aware of.

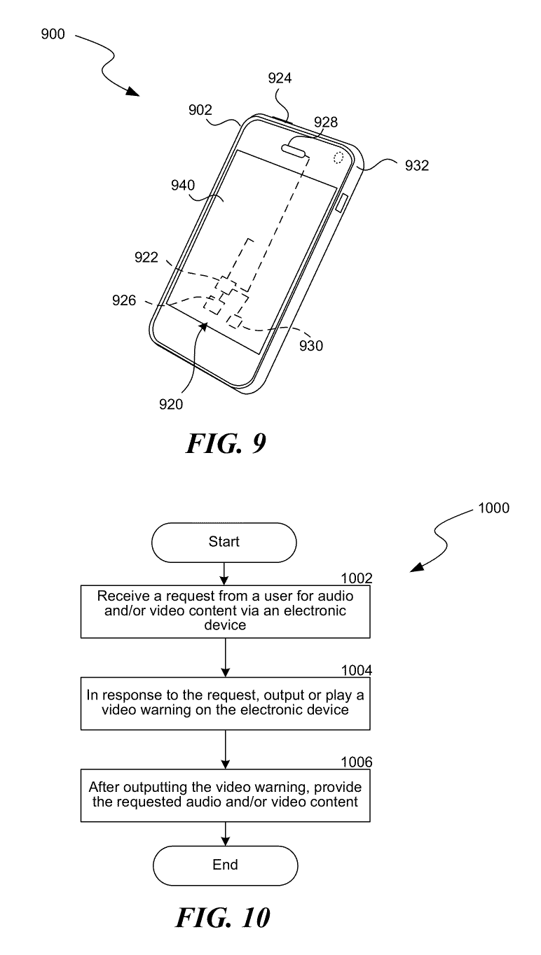

FIG. 9 is a schematic isometric view of a communication apparatus 900 having a video warning system 920 configured in accordance with still another embodiment of the present technology. In the illustrated embodiment, the communication apparatus 900 is a smart phone. As will be appreciated by one of ordinary skill in the art, however, the communication apparatus 900 can include various other apparatuses, devices, and/or structures (e.g., cellular phones, PDAs, etc.). The apparatus 900 includes a body 902 carrying the video warning system 920 and a video screen 940. In the illustrated embodiment, the video screen 940 is a touch screen that, in addition to displaying video and other graphical information, operates to receive input from a user. The device 900 can also include an antenna 932 to receive an audio signal, a video signal, and/or a data signal.

The video warning system 920 can be generally similar in structure and function to the video warning systems described above. For example, the video warning system 920 can include a processor 922 operably coupled to each of an on-off control 924, a data storage medium 926, a speaker 928, a power source 930, the antenna 932, and the video screen 940. The video warning system 920 can output a video warning that includes safety information associated with use of the apparatus 900. In some embodiments, the video warning system 920 can output more than one video warning and/or warnings in more than one language. The video warning can also be a standardized safety message that is unalterable by the user. In addition to the embodiments described above, the processor 922 can be configured to include “smart” features, including logic or other programming features, thus enabling the video warning system to activate based on various types of potentially dangerous uses of an electronic device. Additionally, video warnings contained in the data storage medium 926 can be updated via a signal received by the antenna 932. The signal can include updated video warnings and/or other data, including software updates to the video warning system 920.

Although FIGS. 8A and 9 illustrate specific embodiments of an electronic device and communication apparatus, respectively, the present disclosure is not limited to video warning systems 820, 920 combined only with the illustrated embodiments. The video warning systems and associated video warnings described herein can be used with various types of electronic devices and apparatuses having pre-existing video and/or sound output capabilities, including, for example, consumer and commercial electronics, cordless phones, portable multimedia devices, global positioning systems, televisions, video recorders, video playback devices, optical and viewing enhancement equipment, PDA's, computers and computing devices, magnification and enlargement devices, game playing devices, toys, radar and laser speed detectors, projectors, laser pointers, stereos, home theater equipment, and the like.

FIG. 10 is a schematic flow diagram of a routine 1000 for providing audio and/or video content to a user of an electronic device. The routine 1000 can be contained on computer readable medium (e.g., the data storage medium 826, 926 of the electronic device 800 or the communication apparatus 900, respectively). The process 1000 includes receiving a request from a user for audio and/or video content via an electronic device (block 1002). The process 1000 further includes outputting or playing a video warning on the electronic device in response to the request (block 1004). In some embodiments, the video warning can include a safety message relating to use of the electronic device. The process 1000 further includes providing the requested audio and/or video content after outputting the video warning (block 1006).

Video warning labels can also be made to be interactive when played on a smart device. A single video warning label can be used for multiple similar products, devices, or items with a query to the user, who makes a specific selection, and the video warning label plays additional specific warning material. User interactive features can also be used to register the user's viewing of the video warning label, add these to a user's catalog of video warning labels viewed, or enable other add-in videos or video features.

From the foregoing it will be appreciated that specific embodiments of the invention have been described herein for purposes of illustration, but that various modifications may be made without deviating from the spirit and scope of the various embodiments of the invention. For example, although the illustrated embodiments include video screens on cellular phones, video screens for video warnings may be part of video and music players, GPS navigation systems, televisions, computers, or other devices that include screens. Furthermore, although an illustrated embodiment includes a video screen attached to a table saw, video screens for the video warning system can be added or affixed to a multitude of other devices, including miter saws, drills, chain saws, ladders or other equipment. Additionally, while features of the technology disclosed herein have been described in relation to one or more embodiments, the features of the present technology can be combined in a variety of other suitable manners. Moreover, while various advantages and features associated with certain embodiments have been described above in the context of those embodiments, other embodiments may also exhibit such advantages and/or features, and not all embodiments need necessarily exhibit such advantages and/or features to fall within the scope of the disclosure. Accordingly, the invention is not limited, except as by the appended claims.

I/We claim:

1. A product manual, associated with a device, product, or item, the product manual comprising:
a processor;
a video screen and a speaker operably coupled to the processor; and
a computer readable medium operably coupled to the processor, the computer readable medium including—
a video warning associated with the use of the device, product, or item; and
instructions that when executed cause the video screen and the speaker to broadcast the video warning, wherein the video warning is supplied by at least one of a manufacturer, supplier, distributor, retail vendor or other interested party of the device, product, item, or of a software application installed on the device, product, or item.

2. The product manual of claim 1 wherein the video warning is a first video warning in English, wherein the computer readable medium further includes a second video warning in a language other than English, and wherein the instructions cause the video screen and the speaker to broadcast at least one of the first video warning and the second video warning.

3. The product manual of claim 1, further comprising an input device for receiving user input, wherein the video warning is a first video warning in English, wherein the computer readable medium further includes at least one additional video warning in a language other than English, and wherein the instructions cause the speaker to broadcast one of the video warnings in response to user input that selects the language in which the video warning will be broadcast.

4. The product manual of claim 1 wherein the video warning is a first video warning, wherein the computer readable medium further includes a second video warning, different from the first video warning, and wherein the instructions cause the video screen and the speaker to broadcast at least one of the first video warning and the second video warning.

5. The product manual of claim 1 wherein the cause the video screen and the speaker to broadcast the video warning a predetermined number of times before silencing the video warning.

6. The product manual of claim 1, further comprising means for updating the video warning.

7. The product manual of claim 1 wherein the video warning includes a code, and wherein the device, item, or product is at least partially disabled until a user verifies that the video warning has been viewed by entering the code into an input device.

8. A product manual associated with a device, product, or item, the product manual comprising:
computer readable media containing—
product instructions and safety information; and
a video warning associated with the device, product, or item, wherein the video warning is supplied by at least one of a manufacturer, supplier, distributor, retail vendor or other interested party of the device, product, item, or of a software application installed on the device, product, or item.

9. The product manual of claim 8 wherein the video warning is a first video warning in English, wherein the computer readable medium contains a second video warning in a language other than English.

10. The product manual of claim 8 wherein the video warning is a first video warning, and wherein the computer readable medium contains a second video warning, different from the first video warning.

11. A computer implemented system for video warnings, the system comprising:
a database having at least one video warning associated with a device, item, or product and at least one product safety manual associated with the device, product, or item; and
a computer readable medium having instructions that when executed logs each viewing of a video warning or of a product safety manual.

12. The system of claim 11, wherein the computer readable medium further includes instructions that when executed provide a reward for the viewing of the video warning or the product safety manual, wherein the reward consists of at least on of A) information to enable the use of the device, item, or product; B) enabling the use of special features of the device, item or product; C) electronic certificates that can be collected by a user, wherein the electronic certificates signify that the user has viewed the video warning or the product safety manual; D) discounts, coupons or gift certificates offered by a manufacturer, supplier, distributor, or retail vendor of the device, or by another interested party.

13. The system of claim 11, wherein an internet based social media site is used to log the viewing of a video warning or of a product manual.
